(19) United States
(12) Patent Application Publication
(10) Pub. No.: US 2014/0052776 A1
(43) Pub. Date: Feb. 20, 2014

(54) SYSTEM FOR BUILDING CUSTOMER RELATIONSHIPS THROUGH SOCIAL MEDIA

(71) Applicant: Davin E. Lafon, Pittsburgh, PA (US)

(72) Inventor: Davin E. Lafon, Pittsburgh, PA (US)

(21) Appl. No.: 13/968,959

(22) Filed: Aug. 16, 2013

Related U.S. Application Data
(60) Provisional application No. 61/683,899, filed on Aug. 16, 2012.

(51) Int. Cl. H04L 29/06

(52) U.S. Cl. CPC H04L 29/06047
USPC 709/203

(57) ABSTRACT

A communications platform (10) that includes at least one digital device (12), a platform server (14) and a sponsor device (18) wherein the platform server (14) is capable of configuring a device application that runs on the digital device (12) in accordance with actions and benefits that are defined by an inducement rule that is created in the sponsor device and provided to the platform server. The communications platform (10) cooperates with at least one social media server (22) to monitor for social media actions as defined by the inducement rule and affords benefits to the digital device that correspond to the actions under the inducement rule.

### BACKGROUND OF THE INVENTION

1. Field of the Invention

The presently disclosed invention concerns systems and methods for building customer awareness and loyalty through a digital network and, more particularly, a system for exploiting social media to acquire customer information, increase brand visibility to new customers and to create and build customer loyalty.

2. Discussion of the Prior Art

For many years, merchants and businesses have tried many ways to attract and maintain customers. Often, they have relied on incentives such as discounts and special promotions that were intended to achieve various sales and marketing objectives such as enhancing sales, building brand recognition, increasing market share and many others. In most cases, acquiring data concerning consumer preferences and interests as well as profiles of optimal customers was a separate process that was often preliminary to designing sales and marketing strategies.

In the prior art, the distribution of such customer incentives was often slow, costly and somewhat labor intensive. In many cases, this was done by advertising in newspapers or magazines of general circulation. Other methods included mass mailing promotional materials to various commercial address lists or by advertisements over broadcast media such as radio and television. However, these methods were found to be inadequate and wasteful in many cases. For example, print advertisements are subject to some period of delay before the copy is created, placed and distributed. Often, that made such advertisements untimely. Moreover, print advertising has inherent limitations as to its content. For example, color copy is not always possible for reasons relating to publishing capability. Also, copy size is frequently an issue for reasons of cost or practical presentation. Some media such as video and audio is generally not even possible. Moreover, all of these venues tended to be inefficient from the standpoint that the advertisements were presented to a broad universe of persons, even when it was known that prospective customers composed only a relatively minor population in that universe.

The advent and rapid growth of subscription media services such as cable and satellite television and subscription radio has spawned various proposals for defining a more targeted customer universe. Those efforts have somewhat improved efficiency in promoting goods and services. However, inherent limitations still create difficulties in terms of cost and timeliness. For example, to the extent that subscription media services rely on copy, there are still delays in the process of involving ad agencies and others in the process of creating, placing and publishing the copy. Moreover, these methods have done nothing to integrate sales efforts with the collection of useful marketing data.

Methods have been proposed for more precisely targeting the universe of potential customers by means of set top boxes and other supervisory controls. However, the precision of those methods is limited by the degree of system granularity that is technically possible and inherent randomness as to the audience that actually views the message. Moreover, such systems carry additional cost and many potential users resist them for reasons of technical complexity.

Significant to all advertising methods mentioned above, there has been a dramatic shift in user preferences away from print media of all types toward information sources that are available through the Internet. Consequently, a number of “on-line” proposals have been developed for promoting businesses. Those have included schemes for distributing discount coupons and other promotional devices through Internet channels. However, those systems still suffer from shortcomings in that they fail to identify, access and maintain a sufficiently large population of potential customers. Like many of the predecessor “hard copy” promotional schemes, many recent Internet-based systems have limited features that are essentially the distribution of promotional coupons in electronic form.

The trend toward reliance on Internet sources for news and information is especially pronounced in younger persons. They manifest a strong preference for engaging focused websites that specialize in the subject that is of immediate interest such as the weather or local traffic conditions. Another strong trend that has developed is a preference for communicating with friends and associates through social media websites of the type that allow users broad self-expression such as by building personalized pages and establishing unique communication groups.

While these technical constructs and social trends have been limiting for historical types of advertising and merchandising, they again afford new opportunity. Social media and other Internet websites are famously inexpensive to maintain and are becoming increasingly user-friendly in terms of complexity. It was seen that changing demographics would tend to strongly support a system that could use social media to build customer recognition and loyalty. Moreover, it was also recognized that an Internet system that was interactive with users of social media would have a significant opportunity to acquire valuable consumer information as well as an advantage in promoting goods and services, particularly if that system could cause or encourage customers to use their own social media feeds to ‘endorse’ a brand or product to their friends in the form of positive reviews.

Accordingly, there was a need in the prior art for a social media based Internet system of identifying those customers who are favorably predisposed toward a particular vendor's goods or services. Preferably, the same system could be used to develop stronger relationships with customers or potential customers. Such a system should not be technically complicated so that it could be interactive with the social media user and also relatively easy for merchants and businessmen to use. In addition, the system should be flexible and readily scalable so that businesses could grow the system without undue commitments of time and effort.

Such a system would be particularly valuable if it could ‘shape’ traffic on social media, not just in terms of the brand's own identity (e.g. Facebook page), but in terms of the identities of the targeted consumers (e.g. endorsed recommendations posted to their own pages). Such a system could quickly and easily deliver a promotional message and continuously develop a growing body of customer-related data by cataloging those endorsed recommendations. By building a database of such encouraged endorsements, such a system would be useful in dynamically supporting marketing efforts by allowing continued targeting of advertisements aimed at the emerging preference profiles.

### SUMMARY OF THE INVENTION

In accordance with the presently disclosed invention, a communications platform identifies activities of social media users that a trade or business deems to be favorable and encourages those activities by bestowing benefits on the social media users in response to the favorable activities. The social media users or other users of digital devices are rewarded for actions that have a positive result for the trade or business. In this way, the platform encourages interaction with social media users that strengthens the brand of the trade or business and that markets products to the same users. The rewards level to favorably influence the users' behavior in a way that strengthens broad engagement. Examples include rating, recommending, reviewing, and publicizing goods or services of the trade or business. The trade or business authors inducement rules that select the actions that are rewarded and controls the reward that results from each particular action.

The communications platform also supports interaction with social media users to provide an effective and efficient mechanism for the trade or business to acquire information that is relevant to the interests and purchasing practices of customers and potential customers. The communications platform also encourages and facilitates social media users' voluntary participation in expanding the communications platform without the commitment of substantial time and expense of the trade or business.

The elements of the communications platform include at least one digital device, a platform server, and a sponsor device. The digital device includes a device application and is responsive to user commands that cooperate with the device application to control the digital device. The platform server is capable of configuring the device application in response to the detection of actions that are defined by an inducement rule. The inducement rule also defines benefits and one or more associative relationships between the actions and the benefits.

The sponsor device creates the inducement rule based on personal profiles and other information that is acquired from the digital device through interaction of the user of the digital device with the sponsor's brand, products, services or other points of contact. In one embodiment, the digital device sends data to the platform server from which choices, preferences, interests and other information relevant to the user can be inferred. The data is made available to the sponsor device for purposes of creating an inducement rule that is personalized to the particular needs and objectives of the sponsor.

When the user of the digital device causes the digital device to take an action that is defined by the inducement rule, the data sent to the platform server is recognized as the execution of a desired action. To encourage and incentivize repetition of the same or similarly desirable actions in the future, the platform server determines from the inducement rule a benefit that corresponds to the action. The benefit is then transferred to the digital device. In some cases, the benefit is transferred by the platform server configuring the device application on the digital device to generate the benefit. In other cases, the platform server may create the benefit directly and transfer it to the digital device.

In some cases, the communication platform cooperates with at least one social media server and the data that the digital device sends to the platform server further includes information that is exchanged between the digital device and the social media server. In those cases, the information available from the digital device is enriched by information concerning the user's social media experience so that more detailed information is available, not only from the user, but also indirectly from other social media users. In some cases, some or all of this information is transferred to the sponsor device for use in developing inducement rules and other businesses purposes.

In some cases, the information that is sent to the platform server includes profile information of the digital device, or profile data from social media servers. Social media profile data may be transferred to platform server via the digital device, or it may be transferred directly from social media servers to the platform server using techniques known to those who are skilled in the art. Using such profile information, the sponsor device can create highly specific messages that are tailored to a particular class of profiles. The message is sent to the platform server and the profile information is again used to send that message only to those digital devices that fall within that class of profiles.

For certain embodiments, the action on the social media does not have to initiate from the communication platform to be made available to the platform server or for a benefit to be granted. This means that if the user of a digital device that is an element of the communication platform uses another device that is not platform-enabled, the benefits to both the sponsor and the user still result. In some cases, the platform server is authorized to monitor the user's id portal on the social media server and report a detected action that is defined in the inducement rule to the communications platform. In other cases, the digital device is authorized to monitor the user's id portal on the social media server and report the detected action. In either case, the action can be initiated through another device that uses the user's id portal but that is not an element of the communications platform. The action still will be reported and the benefit still will be conveyed to the user's digital device.

In still another embodiment, an interrelationship between social media users and the communications platform can be used to incentivize social media users to expand the communications platform. A digital device that is on the platform can post an address for a copy of the device application to a social media “friend.” When the friend visits the post, they can secure the copy of the device application and install it on their digital device to add their digital device to the communications platform. When the friend secures the copy of the digital application, they also receive a code for a benefit that was posted with the address for the copy of the device application. The code is executed to automatically push the benefit to the digital device of the friend. Thus, the friend has even added incentive to join the communications platform.

In brief, the system provides the benefits identified as lacking or missing in the prior art. It allows sponsors to (a) detect consumer interaction with social media on the behalf of a brand or sponsor, (b) encourage favorable consumer interaction with social media by transmitting coupons and other rewards (i.e. “inducements”) and (c) automatically compiles a database of those favorable consumer interactions that enable sponsors to (d) market products and brands to consumers in a more targeted fashion. It allows sponsors to do all of this as an automatic, computerized service that can be configured to fit the sponsor's unique marketing needs. It can also spread via social media automatically, adding new consumers to the network without direct human intervention.

Other objects, features and advantages of the presently disclosed invention will become apparent to those skilled in the art as several presently preferred embodiments thereof proceeds.

### BRIEF DESCRIPTION OF THE DRAWINGS

Several presently preferred embodiments of the presently disclosed invention are shown and described in connection with the accompanying drawings wherein:

FIG. 1 is a diagram of a presently preferred embodiment of a basic communications platform that is further described herein;

FIG. 2 is a diagram of the communications platform that is illustrated in FIG. 1 and further including a social media component;

FIG. 3 is a diagram of the communications platform shown in FIG. 2 and further including capability for monitoring activity of an extra-platform device;

FIG. 4 is a diagram of the system illustrated in FIG. 1 and further including association with a global positioning system; and

FIG. 5 is a diagram of the embodiment illustrated in FIG. 3 and further illustrating the scalability features of the communications platform.

### DESCRIPTION OF PRESENTLY PREFERRED EMBODIMENTS

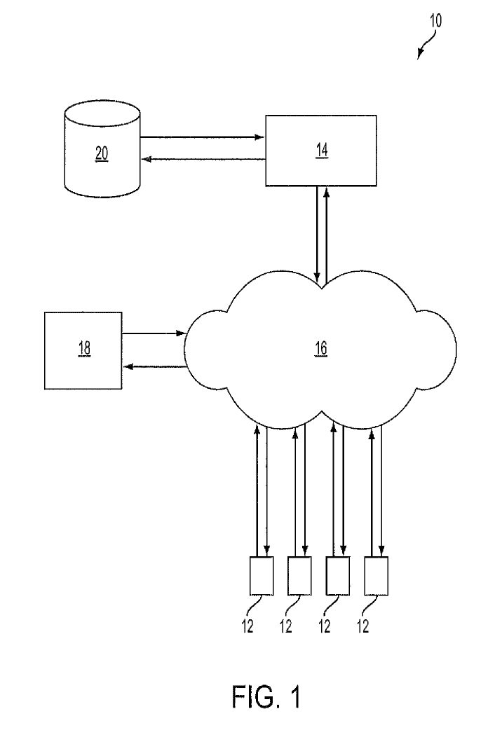

A presently preferred embodiment of the presently disclosed invention is shown and described in connection with FIG. 1 wherein a communications platform 10 that is sustainable and interactive with social media networks is illustrated. The communications platform 10 of FIG. 1 is especially focused on collecting and using information that is germane to sales and marketing strategies through the normal, daily activities of social media users.

Communications platform 10 includes a plurality of digital devices 12. Each digital device 12 includes software that is referred to herein as a device application and an affordance. The affordance can be a keyboard or other device that is responsive to commands such as keystrokes from a human user. As will be apparent to those skilled in the art, the affordance is responsive to user commands such that the affordance cooperates with the application to control digital device 12.

In practice, digital devices 12 can be any device that is capable of communicating with other electronic elements though Internet connections or otherwise. Examples of such devices are a website and associated software, a mobile electronic device, and a desktop computer. In cases of a mobile electronic device and a desktop computer, the device application associated with the digital device may be an application that resides on the mobile electronic device or the desk top. Examples of mobile electronic devices are seen in cell phones, laptop computers and electronic tablets.

Each of the digital devices 12, separately and independently, is an element of the communications platform 10. Each of the digital devices 12, separately and independently, is in communication with a platform server 14, In the example of FIG. 1, the digital devices 12 communicate with platform server 14 through Internet connections represented at 16.

Platform server 14 is another element of the communications platform 10. Platform server 14 may be an electronic server of the type that is compatible with Internet use. Platform server 14 includes software that resides on the server and that is referred to herein as a platform application. Platform server 14 is capable of configuring, independently and separately, the device application on each digital device 12 at times when the platform server and the digital device are in communication through Internet 16.

The promoters of goods and services are generally referred to herein as “sponsors,” referencing that a business model for the disclosed system may be that such persons' participation on the communications platform 10 could be fee-based. The embodiment of FIG. 1 further includes a sponsor device 18 that may be a computer and that forms another element of communications platform 10. Sponsor device 18 includes sponsor software and an affordance that may be a keyboard or other device that is responsive to commands, such as keystrokes, from a human user. As will be understood to those skilled in the art, the affordance and the sponsor software cooperate to control sponsor device 18 in response to commands to the affordance. Sponsor device 18 is in selective, two-way communication with platform server through Internet 16. At times when sponsor device 18 is in communication with platform server 14 through Internet 16, the sponsor device receives information from the platform server 14 and sends instructions to platform server 14 in response to user commands to the affordance on the sponsor device.

Communications platform 10 provides for merchants and other advertisers to inexpensively and reliably provide product and service promotions to a highly defined universe of customers and potential customers. Furthermore, advertisers and promoters who use communications platform 10 can rapidly and easily remove, replace or modify any promotion, even after it has been published.

Referring to the embodiment shown in FIG. 1, a sponsor may develop an inducement rule that relates the performance of actions that the sponsor desires of customers or potential customers to a benefit or prize. The role of the disclosed system in acquiring information to support the sponsor's development of an inducement rule that is unique to the sponsor's trade or business is hereinafter more fully explained. The inducement rule can be any relationship of actions and benefits that the sponsor may choose. For example, actions of an inducement rule may include actions of a social media user in connection with rating, recommending, reviewing or publicizing the sponsor's products. The inducement rule can relate all or each of those actions to one or more benefits such as a discount certificate that can be used at the sponsor's place of business. For example, the rule may offer a coupon to any user that rates or reviews ten items in the sponsor's product inventory, “liking” the social media page of the sponsor, or posting positive recommendations or coupons of the sponsor on a social media network.

Referring to FIG. 1, the sponsor uses commands to the affordance of the sponsor device 18 to cause the sponsor device to send an individually tailored inducement rule to the platform server 14. As explained previously, digital device 12 sends information to platform server 14 in response to user commands to the affordance of digital device 12. For example, the human user of digital device 12 may visit an Internet website in which the user rates a product that is of interest to the sponsor. The keystrokes and other information concerning that site visit and product rating is included in the information that is sent to the platform server 14. In this way, the information from digital device 12 to platform server 14 includes information as to the actions of the user of digital device 12.

In an embodiment, platform server 14 compares information from digital device 12 to the actions that are defined in the inducement rule that platform server 14 receives from sponsor device 18. If the comparison shows that the user of the digital device 12 performed one of the actions defined by the sponsor's inducement rule, platform server 14 configures the application on the digital device 12 so as to cause the digital device to generate a benefit. As an example, the action could be posting a favorable review of a product and the benefit could be a coupon that the user of the digital device could redeem with the sponsor. In some cases, the benefit may also include information concerning the sponsor or certain products or services that the sponsor wants to promote. In accordance with the disclosed invention, the communication platform is made interactive with social media users by linking the award of a benefit to the social media participant to an action that the sponsor values as desirable by associating the action and the benefit in the inducement rule.

In some cases, platform server 14 communicates the inducement rule to the device application on digital device 12 and the benefit is generated directly from digital device 12. An advantage in this structure is that the rewards or benefits can be delivered by the digital device irrespective of whether the digital device is in communication with platform server 14.

In some cases, platform server 14 may also provide to sponsor device 18 information from the digital device in addition to the “action” that was taken. Sponsor device 18 may then use this information to further analyze the actions of the social media participant to assess buyer tendencies, level of interest, product selection and other information that may be of interest to the sponsor. In this way, a sponsor can reward the user of the digital device for engaging with the sponsor's product or brand in a particular way that the sponsor deems desirable. In exchange, the sponsor can acquire information concerning the specific user's choices, selection process or other information that adds value to the sponsor's trade or business.

To augment the capability of communications platform 10 to analyze buyer behavior, customer preferences and other information that is of interest to a sponsor, communications platform 10 further includes a platform database 20 that is in communication with platform server 14. Platform database 20 can be used to store some or all of the information that digital device 12 sends to platform server 14 in response to user commands to the affordance of digital device 12. Examples of such information may include phone id's, profiles of social media users (e.g. age, location, social media “friends”), product rating profiles, broad engagements, and application usage profiles (e.g. application usage habits). Additionally, database 20 can be used to store information concerning the sponsor's goods and services. In this way, the information can be stored and compiled so that platform server 14 can access and manage a larger body of data and make some or all of that data available to the sponsor device 18 for further analysis and for use in designing inducement rules.

In some cases, the information from digital device 12 to platform server 14 may include information that profiles the user of the digital device. Where multiple digital devices 12 report information to platform server 14, multiple user profiles may be stored in database 20. Thereafter, sponsor device 18 may send instructions to platform server 14 to cause platform server 14 to make such profile information available to sponsor device 18 for analysis.

In some cases, the instructions from sponsor device 18 may define certain types or classes of user profiles. This may be used to cause platform server 14 to configure the device applications of digital devices 12 corresponding to selected user profiles. The result is that only those digital devices 12 associated with the selected types or classes of user profiles are configured. In other cases, the platform server 14 may configure selected digital devices in accordance with actions that are defined by the sponsor instructions to cause the digital device to generate a benefit in response to an action by the digital device that is defined by the inducement rule on platform server 14. Because the inducement rule links actions desirable to the sponsor with benefits desirable to the user, the users that are associated with configured devices receive benefits that are relevant to their tastes or interests.

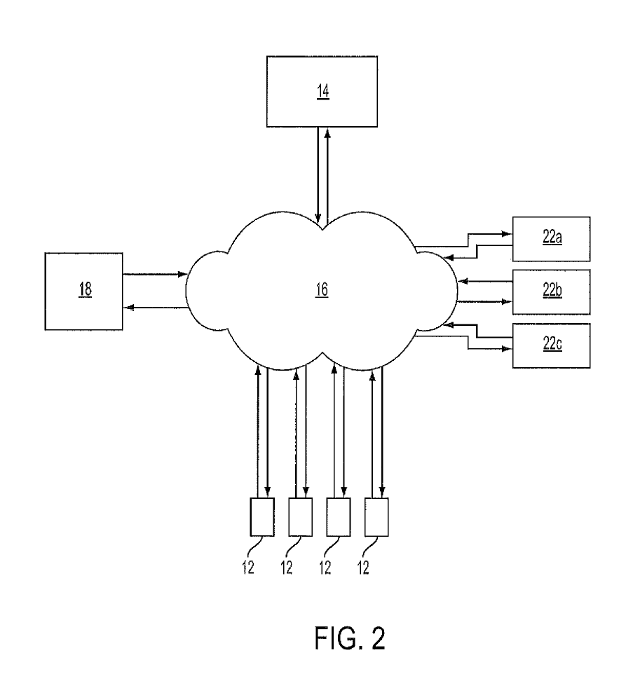

FIG. 2 is a diagram of a system in accordance with the presently disclosed invention wherein features that are like-numbered with respect to the diagram of FIG. 1 are the same as the features that are described in connection with FIG. 1. Additionally, the embodiment of FIG. 2 further includes a plurality of social media servers 22a, 22b and 22c that are servers such are used in Facebook® and Twitter® systems wherein account holders post and exchange information. Often, such information is of a personal nature and access may be restricted by the account holder to a limited universe of persons who may be denominated as “friends” or otherwise identified as being given special access to the holders account.

In the embodiment of FIG. 2, digital device 12 is in selective communication with one or more social media servers 22a-c through Internet connections of the type that are known to those skilled in the art (referred to generally as “social media server 22”). In FIG. 2, the device application on digital application device 12 modifies the information that the digital device sends to platform server 14 in response to inputs to digital device 12 from social media server 22. Specifically, the device application of the digital device modifies the information sent to platform server 14 in accordance with inputs from social media server 22 so as to inform or enhance the information that digital device 12 sends to platform server 14 to reveal actions at social media server 22. In this way, communication between the digital device and the social media server are used to modify the information sent to the platform server 14.

In some cases, sponsor device 18 may configure the actions in an inducement rule in accordance with specific social media actions. For example, sponsor device 18 may configure the inducement rule to have a benefit that corresponds to an action in which a favorable comment concerning the sponsor's product is posted on social media server 22.

In some cases, platform server 14 communicates the inducement rule to the device application on digital device 12. When so desired, the sponsor device 18 may instruct platform server 14 to communicate the inducement rule only to a selected set of digital devices. In this way, the publication of specific benefits can be more precisely targeted to a specific universe of potential users. Such selected sets of digital devices can be established according to various criteria as defined by sponsor device 18. For example, when the inducement rule includes actions that relate to social media server 22, sponsor device 18 can instruct platform server 14 to communicate the inducement rule only to digital devices 12 having a profile that includes past communication with social media servers or in which the digital device has a predetermined association with the sponsor or with selected products or services.

In an example, sponsor device 18 may create a particular profile for distribution of the inducement rule. Such profiles can be based on information that was collected from the digital device 12. The sponsor device 18 can then send the profiles along with a targeted message or a gratuitous benefit to platform server 14. Platform server 14 then distributes the message and/or benefit to digital device 12 fitting that profile. The result is that the messages/benefits are highly targeted. They are delivered only to digital devices with a profile that is predictive that the information/benefit will be relevant to the user and will not be discarded as “spam”.

In some cases in which the inducement rule is communicated from the platform server 14 to the digital device 12, the inducement rule may include actions that relate to a social media server. In those cases, the digital device 12 may integrate the device application with inputs to the digital device from the social media server to enable the device application to detect actions that are defined by the inducement rule, The digital device then generates benefits when the enabled application detects an action within the set of actions that are included in the inducement rule.

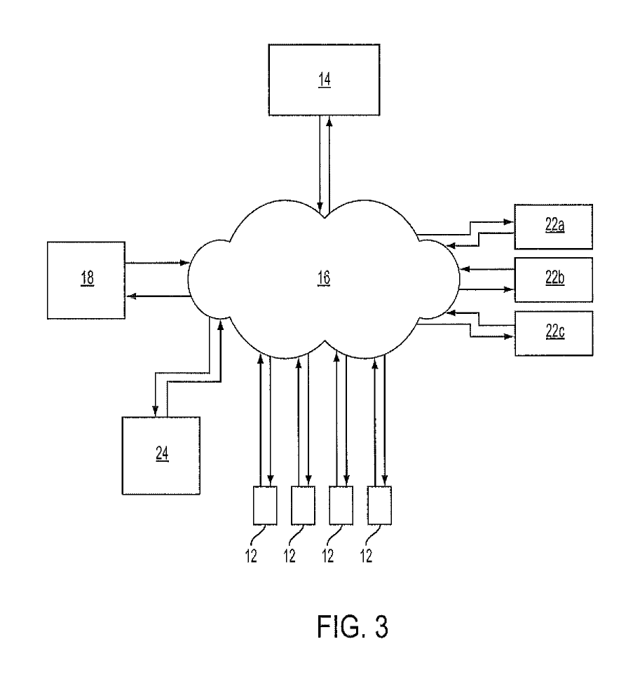

FIG. 3 is a diagram of another embodiment of the disclosed invention that is similar to the diagram of FIG. 2 and wherein like components are identified with corresponding reference characters, FIG. 3 illustrates one embodiment of how the presently disclosed invention can be used to provide benefits to a device 12 that is an element of the communications platform 10 even when the action in the inducement rule is satisfied by a digital device that is not included in the communications platform 10.

In the embodiment of FIG. 3, digital device 12 communicates with platform server 14 through Internet connections and sponsor device 18 also communicates with platform server 14 through Internet connections as explained in connection with FIG. 2. In addition, FIG. 3 includes a digital device 24 that may be similar to any of digital devices 12 except that digital device 24 does not have a device application by which digital device 24 can communicate with platform server 14. However, digital device 24 can communicate with social media server 22 through Internet communications as known to those skilled in the art.

In the embodiment of FIG. 3, digital device 12 provides information to platform server 14 that authorizes platform server 14 to monitor at least one of the social media servers 22 for a defined activity. When platform server 14 identifies the defined activity at social media server, the platform server configures the device application on digital device 12 to cause the digital device to generate a benefit corresponding to the defined activity. Alternatively, platform server 14 can transmit the benefit to digital device 12 using “push” technology.

As an example, the user of digital device 12 may be prompted to grant the device application on the digital device certain privileges at the time that the application is downloaded and activated. In the example of FIG. 3, the device application is granted the privilege of reading the user's social media streams using standard social media plugins and dialogs. As part of this process, the social media user id corresponding to digital device 12 is transmitted to platform server 14. Thereafter, subject to limitations imposed, restrictions on using an id that is transferred from digital device 12, platform server 14 monitors the social media feeds corresponding to that id for actions that correspond to one of the actions defined by a sponsor inducement rule. When platform server 14 identifies a defined action, the corresponding benefit it sent to digital device 12. The benefit will be sent to digital device 12 even if the action that satisfied the rule was executed through digital device 24 (which does not have a device application and therefore is not considered an element of the communication platform). That is because the benefit is granted based on monitoring the social media stream at social media server 22 and in response to the defined action at the social media server 22—not at either of the digital devices 12 or 24. As an example, the user of digital device 12 may use digital device 24 to “like” a sponsor while surfing Facebook®, Based on that activity, the platform server 14 then sends a benefit such as a discount coupon via a “push” message to the device application on digital device 12.

An alternative embodiment of the system shown in FIG. 3 affords a somewhat higher degree of security by maintaining the social media user id on digital device 12. In this embodiment, the application on digital device 12 secures the social media server id at the time of activating the device application. However, the social media server id is retained on the digital device 12 and is not sent to platform server 14. Platform server 14 does not communicate with social media server 22. Instead, digital device 12 is in communication with social media server 22 through Internet communications 16.

Platform server 14 configures the device application on digital device 12 to authorize digital device 12 to monitor social media server 22 for an activity defined by the inducement rule. Platform server 14 also configures the device application to generate a benefit when digital device 12 recognizes the defined activity on social media server 22, When digital device 12 identifies an action at the social media server feed that is defined in the inducement rule, the digital device 12 issues the corresponding benefit according to the inducement rule. Alternatively, digital device 12 can inform platform server 14 that a defined action has been detected so that platform server 14 sends the corresponding benefit to digital device 12. Again, it does not matter if the defined action was executed through digital device 24, which is not in the communication platform, because the action is identified by monitoring the feed to the social media server 22—not the digital device 24.

The defined action may be any action that is of interest to the sponsor that created the inducement rule. For example, the action could be a reference on the social media server to the sponsor or to particular goods or services of interest to the sponsor,

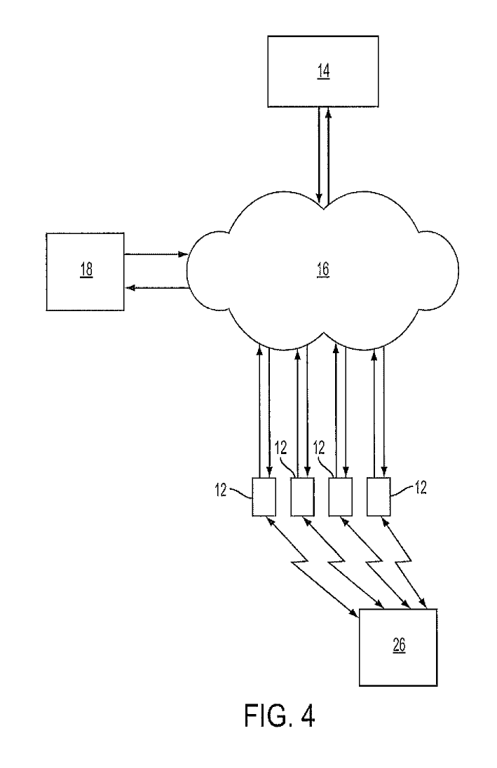

Referring to FIG. 4, another embodiment of the presently disclosed invention includes components of the system shown in the diagram of FIG. 1 for which like components are identified with the same reference characters. The system of FIG. 4 further includes a global positioning server 26. Digital device 12 is in communication with global positioning server 26 by transmitted signals as is known by those skilled in the art. In the embodiment of FIG. 4, platform server 14 configures the application on digital device 12 to authorize monitoring of the global positioning server with respect to a defined location. For example, platform server 14 may authorize monitoring of the global positioning server with respect to an area that is within 50 feet of the sponsor's place of business. The platform server 14 further causes digital device 12 to generate a benefit at times when the defined location is reached. In one example, the embodiment of FIG. 4 could result in the digital device 12 generating a benefit such as a discount coupon at times when the user carrying digital device 12 walks past the sponsor's place of business.

In each of the embodiments that are herein described, when the platform server 14 configures the application on digital device 12, the configuration modifies the application. This modification gives the disclosed invention the capability of amending or modifying the application on the digital device so as to change the character of the text, audio and images that compose the benefit or other message from the sponsor, The changes are in the code and the software so as to change the behavior of the digital device.

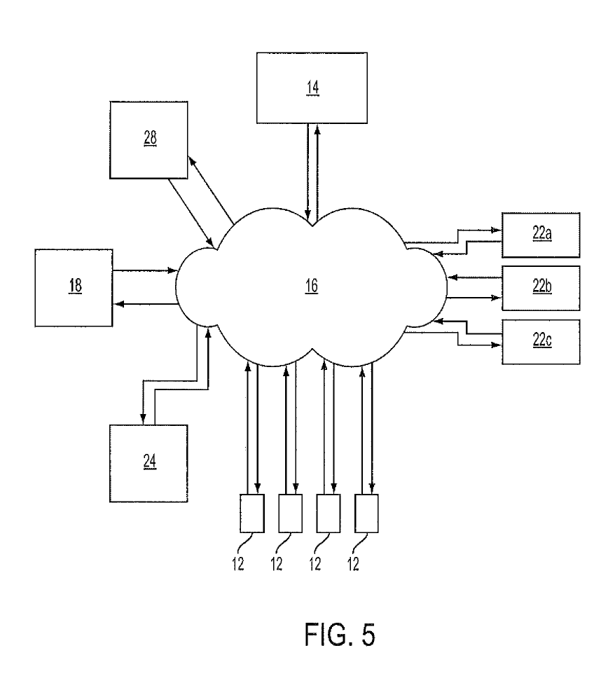

FIG. 5 is an embodiment of communications platform 10 that emphasizes the capability of the presently disclosed invention to increase the number of elements in the communications platform through the voluntary cooperation of existing users of the platform. FIG. 5 includes components of the system that are shown in the diagram of FIG. 3 for which like components are identified with the same reference characters. In addition, FIG. 5 includes an application store 28 from which copies of applications are commercially available. For example, store 28 could be Android Play™ or iOS App Store. In the example of FIG. 5, store 28 could be an application server that includes a copy of the device application that resides on digital device 12. In FIG. 5, the copy of the application includes a URL address to the location on store 28 that will allow any user of digital device to install a copy of the device application.

In the embodiment of FIG. 5, social media server 22 communicates with users according to social media identities that correspond to the respective users. That is, each respective user of social media server 22 has a corresponding id by which they can access authorized portions of the server. Digital device 12 is in communication with social media server 22 in the conventional manner. Digital device 12 is responsive to user commands to the affordance of digital device 12 to secure one or more social media identities of other users such as “friends” on a Facebook® server.

Also using user commands, digital device 12 selects one or more of said identities with the object of inviting users who hold the selected identities to accept a copy of the device application on their digital device 24. Digital device 24 is without the device application that resides on digital device 12. Digital device 24 cannot communicate with platform server 14 so that, at this stage, digital device 24 is outside communications platform 10. To send an invitation and add digital device 24 as another element of the communications platform, digital device 12 sends the URL address of the device application copy that is included in store 28 to the identities that were selected from the social media server 22. A gift code is also provided along with the URL address.

Digital device 24, the prospective digital device for inclusion in communications platform 10, is in communication with social media server 22 through the identity that is selected by digital device 12. When digital device 24 accesses social media server 22, it is presented with the invitation to accept the device application for downloading from store 28. The user of digital device 24 accepts the invitation by providing appropriate operator commands to digital device 24 and digital device 24 obtains the URL address of the copy of the application. Digital device 24 then downloads the copy of the device application from store 28 and installs and activates the copy of the device application on digital device 24 in accordance with procedures that are known to those skilled in the art. In this way, digital device 24 becomes an element of the communications platform 10.

At the time that digital device 24 activates the device application, the device application accesses the social media identity for digital device 24 on social media server 22 and acquires the gift code that digital device 12 previously posted there when posting the URL for the copy of the device application. Digital device 24 then transmits the gift code to platform server 14 to cause platform server 14 to send the benefit to digital device 24. Thus, digital device 24 is given a copy of the device application to make digital device 24 an element of communications platform 10. As an incentive, the user of digital device 24 is rewarded with a benefit for having joined the communications platform 10.

The scope of the presently disclosed invention is not limited by the forgoing presently preferred embodiments, but can be otherwise variously embodied with the following claims.

What is claimed is:

1. A communications platform for identifying a defined population and promoting interaction between said defined population and said communications platform, said platform comprising:
at least one digital device that forms a first element of the communications platform, said digital device having a device application and also having an affordance that is responsive to user commands, said affordance cooperating with said device application to control said digital device;
a platform server that forms a second element of said communications platform, said platform server having a server application that resides on said platform server and communicating with said at least one digital device, said platform server being capable of configuring the device application on said digital device at times when said platform server and said digital device are in communication; and
a sponsor device that forms a third element of said communications platform, said sponsor device being selectively in communication with said platform server and receiving information from said platform server, said sponsor device also having an affordance that is responsive to user commands to cause said sponsor device to send instructions to said platform server in response to said user commands to said affordance.

2. The platform of claim 1 wherein the affordance of said sponsor device causes said sponsor device to send an inducement rule to said platform server in response to user commands to the affordance of said sponsor device, said inducement rule defining at least one benefit, at least one action, and one or more relationships between said benefits and said actions, said digital device sending information to said platform server in response to commands to the affordance of said digital device, said platform server comparing said information from said digital device to said actions and configuring the device application on said digital device to cause said digital device to generate benefits at times when said information from said digital device corresponds to actions that relate to said benefits according to said inducement rule.

3. The platform of claim 2 wherein the platform server sends information received from said digital device to said sponsor device.

4. The platform of claim 3 wherein said sponsor device determines commands that were input to the digital device in accordance with the information from said platform server.

5. The platform of claim 2 wherein said platform cooperates with at least one social media server, said digital device being in selective communication with said social media server and wherein the device application of said digital device modifies the information that said digital device sends to said platform server in response to inputs from said social media server to said digital device.

6. The platform of claim 5 wherein the device application of said digital device informs said platform server of the actions of said digital device.

7. The platform of claim 6 wherein said sponsor device configures actions in said inducement rule in accordance with specific social media actions.

8. The platform of claim 2 wherein said platform server communicates said inducement rule only to selected digital devices.

9. The platform of claim 8 wherein said platform server communicates said inducement rule only to digital devices that have a predetermined association with at least one sponsor of a set of sponsors.

10. The platform of claim 1 wherein said platform cooperates with at least one social media server, said digital device being in selective communication with said social media server and wherein the device application of said digital device modifies the information that said digital device sends to said platform server in response to inputs to said digital device from said social media server.

11. The platform of claim 10 wherein said sponsor device sends an inducement rule to said platform server in response to user commands to the affordance of said sponsor device, said inducement rule defining at least one benefit, at least one action, and one or more relationships between said benefits and said actions, said platform server sending said inducement rule to said device application and said digital device integrating the device application with inputs from the social media server to enable the device application to detect actions defined by said inducement rule, said digital device generating benefits on said digital device at times when the enabled application detects an action that is included in said at least one action of said inducement rule.

12. The platform of claim 11 wherein said digital device further provides information to said platform server in response to actions of said digital device and wherein said platform server sends at least a portion of said information from said digital device to said sponsor device.

13. The platform of claim 1 wherein said communications platform further comprises a platform database that is in communication with said platform server, said digital device sending information to said platform server in response to user commands to the affordance of said digital device and said platform server sending at least a portion of the information from said digital device to said platform database, said platform server also retrieving information stored in said database in response to instructions from said sponsor device.

14. The platform of claim 13 wherein the information from said digital device to said platform server includes user profile information from the digital device.

15. The platform of claim 14 wherein the instructions from said sponsor device includes requests for user profile information.

16. The platform of claim 13 wherein the instructions from said sponsor device define user profiles, and wherein said platform server configures selected digital devices in accordance with the user profiles in instructions from said sponsor device.

17. The platform of claim 16 wherein said platform server configures the selected digital devices in accordance with defined actions to cause said digital device to generate a benefit in response to an action of said digital device that is defined by the platform server.

18. The platform of claim 2 wherein said platform cooperates with at least one social media server that is in communication with said platform server, said digital device providing information to said platform server that authorizes said platform server to monitor said social media server for a defined activity, said platform server configuring the device application on said digital device in response to detection of said defined activity on said social media server to cause said digital device to generate a benefit corresponding to said defined activity.

19. The platform of claim 18 wherein the social media server is in communication with a prospective device that is outside of said communications platform and the defined activity on said social media server comprises communication between said social media server and said prospective device.

20. The platform of claim 19 wherein said prospective device has a social media id and the information that authorizes said platform server to monitor said social media server comprises the social media id.

21. The platform of claim 2 wherein said platform cooperates with at least one social media server and wherein said digital device is in communication with said social media server, said platform server configuring the device application on said digital device to authorize said digital device to monitor said social media server for a defined activity and to cause said digital device to generate a benefit when said digital device recognizes the defined activity on said social media server.

22. The platform of claim 21 wherein the social media server is in communication with a prospective device that is outside of said communications platform and the defined activity on said social media server comprises communication between said social media server and said prospective device.

23. The platform of claim 22 wherein the communication between said social media server and said prospective device includes reference to a sponsor that is included in a group of sponsors.

24. The platform of claim 2 wherein said platform cooperates with at least one global positioning server and wherein said digital device is in communication with said global positioning server, said platform server configuring the device application on said digital device to authorize monitoring of said global positioning server with respect to a defined location and to cause said digital device to generate a benefit when said digital device is within said defined location.

25. The platform of claim 1 wherein the platform server configures the device application on the digital device in accordance with updates to one or more of text, audio or image processing functions so as modify the device application and change the behavior of the digital device.

26. The platform of claim 2 wherein said platform cooperates with
an application server that includes a copy of the device application that resides on said digital device, said application copy being located at a URL address; and
at least one social media server that communicates according to social media identities, said digital device being in communication with said social media server to secure one or more social media identities, said digital device being responsive to user commands to the affordance of the digital device to select said at least one social media identity and send the URL address of said application copy, together with a gift code, to the selected at least one social media identity on said social media server;
a prospective digital device that is outside the communications platform and that is in communication with said social media server through said at least one social media identity, said prospective digital device being responsive to operator commands to obtain the URL address of the copy of the device application included in said application server and to download, install and activate the copy of the device application on the prospective digital device to make the prospective digital device an element of the communication platform, upon activation of the prospective digital device, said device application accessing the social media identity of the prospective digital device on the social media server, acquiring the gift code that was coupled with the URL address of the device application copy, and transmitting the gift code to said platform server to cause the platform server to send a benefit to the prospective digital device.
